(19) United States
(12) Patent Application Publication
(10) Pub. No.: US 2009/0016655 A1
(43) Pub. Date: Jan. 15, 2009

(54) Fluid Dynamic Bearing Device

(75) Inventors: Tatsuo Nakajima, Iwata-shi (JP); Tetsuya Kurimura, Kuwana-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NTN CORPORATION, Osaka-shi, Osaka-fu (JP)

(21) Appl. No.: 11/793,597

(22) PCT Filed: Mar. 15, 2006
(86) PCT No.: PCT/JP2006/305146

§ 371 Date: Apr. 7, 2008

(30) Foreign Application Priority Data
Apr. 1, 2005 (JP) 2005-106580

(51) Int. Cl. F16C 32/06

(52) U.S. Cl. 384/100

(57) ABSTRACT

A fluid dynamic bearing device in which leakage of a lubricating oil can be prevented is provided at low costs.

A minute amount of an ink is provided on a first outer circumferential surface 8b2 of a bearing member 8 made of a sintered metal and a pore sealing portion 17 consisting of aggregates of a minute amount of the ink is formed to seal a portion of the fluid dynamic bearing device 1 of the bearing member 8 which is exposed to the air.

### TECHNICAL FIELD

The present invention relates to a fluid dynamic bearing device which relatively supports a shaft member by the dynamic pressure effect of a fluid (lubricating fluid) existing in a bearing gap. This bearing device has the features such as high-speed rotation, high rotational accuracy and reduced noise, and is suitable as a bearing apparatus for small motors for information appliances, for example, HDD and like magnetic disk apparatuses, CD-ROM, CD-R/RW, DVD-ROM/RAM and like optical disk apparatuses, spindle motors for MD, MO and like magneto-optic disk apparatuses, polygon scanner motors of laser beam printers (LBP), collar wheels of projectors, or electrical machinery and apparatuses such as axial fans.

### BACKGROUND ART

Fluid dynamic bearings of this type are roughly classified into two groups: pressure bearings which comprise a dynamic pressure generating portion for generating a dynamic pressure in a lubricating fluid in a bearing gap; and cylindrical bearings (bearings having a bearing cross section in the shape of a perfect circle) which have no dynamic pressure generating portion.

For example, in a fluid dynamic bearing device integrated into a spindle motor for disk apparatuses such as HDD, both of a radial bearing portion which supports a shaft member in the radial direction and a thrust bearing portion which supports the shaft member in the thrust direction are sometimes constituted by pressure bearings. A known example of bearing members used for fluid dynamic bearing devices of this type is one in which the bearing member is formed of a sintered metal and the inside of the bearing member is impregnated with a lubricating oil so that the bearing member can be used as an oil impregnated sintered bearing (see, for example, JP 2001-65577).

### DISCLOSURE OF THE INVENTION

### Problems to be Solved by the Invention

With a remarkable improvement in performances of information appliances, increasingly high rotational performance is demanded for fluid dynamic bearing devices. Oil impregnated sintered bearings are widely used today since a lubricating oil flows through the inside of pores during the operation of the bearing device and good rotational performance is thus obtained. However, in the fluid dynamic bearing device disclosed in JP 2001-65577, the outer circumferential surface of the bearing member made of a sintered metal is exposed to the air. Therefore, when the bearing device is operated as it is, leakage of the lubricating oil from the outer circumferential surface of the bearing member cannot be avoided. This leakage results in a lowered adhesiveness to brackets in assembling a motor, and further in the contamination of the surrounding environment. Moreover, rotational performance may be lowered by the leakage of the oil and a decrease in the amount of oil in the bearing device.

Accordingly, from the perspective of preventing leakage of the lubricating oil, there are known bearing devices in which the bearing member is accommodated in a housing separate from the bearing member. However, providing the housing separate from the bearing member unavoidably increases the number of parts and the costs because of increased number of parts and thus increased assembling man-hour, and it is thus difficult to meet the requirement of cost reduction in fluid dynamic bearing devices in recent years.

An object of the present invention is to provide a fluid dynamic bearing device which prevents the occurrence of the various problems mentioned above due to leakage of the lubricating oil and has good rotational performance at low costs.

### Means for Solving the Problems

To achieve the object, the fluid dynamic bearing device of the present invention comprises a shaft member, a bearing member made of a sintered metal and provided with the shaft member inserted on its inner periphery, and a radial bearing gap formed between the outer circumferential surface of the shaft member and the inner circumferential surface of the bearing member opposing this and filled with a lubricating fluid, characterized in that a pore sealing portion for sealing pores on the surface by curing aggregates of a minute amount of an ink on the outer circumferential surface of the bearing member is provided.

According to the above constitution, the pores on the surface of the sintered metal are sealed. Therefore, the lubricating fluid filling inside the bearing device can be prevented from leaking out. This can prevent problems such as contamination of the surrounding environment, lowered adhesiveness to brackets, and lowered rotational performance. At this time, no member for accommodating the bearing member needs to be provided on the outer periphery side of the bearing member (for example, a housing). Therefore, a low-cost fluid dynamic bearing device can be provided without increasing the number of parts and assembling man-hour.

In forming the pore sealing portion, aggregates of a minute amount of the ink can be formed, for example, by the so-called ink jet method in which the ink is provided from a pore nozzle in a non-contact state with the outer circumferential surface of the bearing member. Examples of the method for providing the ink in a non-contact state with the bearing member include not only the ink jet method mentioned above, but also the nozzleless-type ink jet method in which ink droplets are ejected not from a nozzle but from the surface of the ink fluid (nozzleless ink jet method), the method of guiding the ink by using electrophoresis, the method of discharging the ink not in a state of droplets but successively by means of a micropipet, the method of discharging the ink and simultaneously hitting the fixation surface with the ink by reducing the distance to the fixation surface, among others.

The methods of providing the ink mentioned above as examples can precisely control the amount of the ink provided. Therefore, by programming in advance and controlling the position of an ink feed section (for example, nozzle) and supply and discontinuation of the ink according to the program, the pore sealing portion can be formed in a desired manner and highly accurately. Therefore, the pore sealing portion can be formed at low costs without conducting a masking process or the like in the portion where the ink need not be provided. Moreover, since the output rate of the ink can be precisely controlled, the pore sealing portion can be formed to have a desired thickness, and an excessive use of the ink can be also prevented.

The method of curing the ink is not critical, and may be heat curing or, for example, curing by the irradiation of an electron beam, light beam, etc. Particularly from the perspective of costs, working circumstances, etc, it is desirable to use a light curable ink and cure the ink by the irradiation of a light beam. The light curable ink used may be visible light curable type inks, as well as ultraviolet curable type and infrared curable type inks, but ultraviolet curable type inks which can be cured at low costs in a short period of time are especially desirable.

As mentioned above, since a sintered metal is a porous body, when the bearing member made of the sintered metal is provided with the ink, the ink may penetrate into the bearing member through the pores and a desired pore sealing portion may not be formed. Therefore, it is desirable to form the pore sealing portion after any pretreatment is conducted so that the ink does not penetrate into the bearing. As the pretreatment, a filling-up process and the like can be also selected, but it is desirable to form a coating of a coupling agent which can be processed at low costs with no special equipment (coupling process). Coupling agents are so-called surface modifiers, and can deteriorate the wettability, in other words, increase the surface tension for an ink. Therefore, penetration of the ink into the bearing when the ink is provided can be prevented.

The coating on said pore sealing portion and coupling agent can be formed in any manner as long as it is formed except for the mating portion with other components which fit the outer circumferential surface of the bearing member. Examples of “other components” include a cover member which seals the opening of the bearing member at one end and a sealing member which seals the opening of the bearing member at the other end. Since both of these cover member and sealing member are generally formed of non-porous bodies, the pores on the outer circumferential surface of the bearing member which serves as a mating portion are sealed by these components. The pore sealing portion and the coating of a coupling agent may be formed in the mating portion with other components if it creates no problem in the workability in fitting other components and the costs.

In the fluid dynamic bearing device according to the present invention, a first bearing portion comprising a dynamic pressure generating portion for generating dynamic pressure effect in the radial bearing gap and a second bearing portion whose radial bearing gap width is smaller than that of the first bearing portion can be formed. According to this constitution, for example, when the bearing device is started and stopped, the shaft member comes in contact with a counter component (the component opposing the shaft member across the radial bearing gap) preferentially in the second bearing portion which has a bearing gap wider than the first bearing portion. Accordingly, the dynamic pressure generating portion of the first bearing portion does not come in contact with the counter component, whereby abrasion of the dynamic pressure generating portion can be avoided so that the function of the dynamic pressure generating portion can be maintained stably for a long period of time. At this time, the second bearing portion can be constituted of a cylindrical bearing.

The width of the radial bearing gap as used in the present invention is the distance between the two faces opposing each other across a radial bearing gap. In the first bearing portion, for example, when the dynamic pressure generating portion is formed on the outer circumferential surface of the shaft portion, the minimum distance between the surface of the dynamic pressure generating portion and the inner circumferential surface of the opposing counter component is “the width of the radial bearing gap”.

The radial bearing gap of the second bearing portion can be formed, for example, between the inner circumferential surface of the sealing member which seals the opening of the bearing member at the other end and the outer circumferential surface of the shaft member. In the second bearing portion, as mentioned above, sliding contact with the outer circumferential surface of the shaft member preferentially occurs. Therefore, the sealing member is desirably formed of a metallic material having high wear resistance. At this time, if the metallic material forming the shaft member and the metallic material forming the sealing member are the same, burning is likely to occur during the sliding contact. Therefore, in case where both members are formed of metallic materials, they are desirably formed of different metallic materials.

The dynamic pressure generating portion may be in any form as long as it can produce a pressure by the dynamic pressure effect of the fluid in the radial bearing gap. Examples include those comprising a plurality of grooves (may be either herringbone grooves or spiral grooves.) and raised demarcation portions which are situated between the grooves and demarcate these grooves, and those having a plurality of arcuate faces which makes the bearing gap contract in one or both of the circumferential directions into a wedge shape, among others.

The dynamic pressure generating portion constituting the first bearing portion can be formed on the outer circumferential surface of the shaft member or the inner circumferential surface of the bearing member opposing this across the radial bearing gap. Widely known methods of forming dynamic pressure generating portions are, for example, a rolling process and cutting process. However, accurately forming dynamic pressure generating portions which require dimensional accuracy on the order of a few micrometers is difficult, and there is also the problem of unavoidable generation of cutting powders produced by the process. If the bearing device is put to use with cutting powders remaining therein, the cutting powders may lower the performance of the bearing as contaminants. Therefore, it is necessary to provide an additional cleaning step or the like to carefully remove the cutting powders, which increases the processing costs.

In contrast, in the present invention, the dynamic pressure generating portion is formed by curing aggregates of a minute amount of the ink. Accordingly, the problems stated above can be overcome and the dynamic pressure generating portion can be formed highly accurately. At this time, since the surface configuration of the outer circumferential surface of the shaft member and the inner circumferential surface of the bearing member may be in the form of smooth surfaces, molding of the shaft member and the bearing member can be readily carried out, and simple molds would suffice. Moreover, since this dynamic pressure generating portion can be formed by the same printing apparatus for forming the pore sealing portion mentioned above, investment in equipment can be cut down.

The fluid dynamic bearing device having the constitution described above can be manufactured at low costs, has high rotational accuracy and durability, and can be suitably used for motors having a rotor magnet and a stator coil, for example, spindle motors for HDD, etc.

### EFFECT OF THE INVENTION

As can be clearly seen from the above, various kinds of problems caused by leakage of the lubricating oil can be prevented and a fluid dynamic bearing device having high rotational performance can be provided at low costs by using the constitution of the present invention.

### BEST MODE FOR CARRYING OUT THE INVENTION

Embodiments of the present invention will be described below with reference to drawings.

FIG. 1 conceptionally shows a constitutional example of a spindle motor for information appliances. This spindle motor for information appliances is used for disk drive units such as HDD, and comprises a fluid dynamic bearing device 1, a disk hub 3 mounted on a shaft member 2 of the fluid dynamic bearing device 1, a stator coil 4 and a rotor magnet 5 which, for example, oppose each other across a gap in the radial direction, and a bracket 6. The stator coil 4 is mounted on the outer periphery of the bracket 6, and the rotor magnet 5 is mounted on the inner periphery of the disk hub 3. The disk hub 3 retains one or more disks D such as magnetic disks on its outer periphery. The fluid dynamic bearing device 1 is mounted inside the inner periphery of the bracket 6. When the stator coil 4 is energized, the rotor magnet 5 is rotated by the electromagnetic force generated between the stator coil 4 and the rotor magnet 5, and the disk hub 3 and the shaft member 2 rotate accordingly.

FIG. 2 shows an example of the fluid dynamic bearing device 1 used in the above spindle motor. This fluid dynamic bearing device 1 comprises, as main components, the shaft member 2 having a shaft portion 2a at the rotational center, a bearing member 8 having a sleeve-like portion into which the shaft portion 2a can be inserted at its inner periphery, a cover member 7 which seals the opening thereof at its one end, and a sealing member 9 which seals the opening at the other end opposite to the cover member 7. In the description below, for the sake of explanation, the side sealed by the sealing member 9 is referred to as the upper side, and the opposite side in the axial direction is referred to as the lower side.

The bearing member 8 is formed, for example, of a sintered metal obtained by compacting a metal powder comprising copper as a main ingredient and sintering the compact. The bearing member 8 integrally comprises a cylindrical sleeve member 8a into which the shaft portion 2a can be inserted at its inner periphery and a protrusion 8b which protrude from the sleeve member 8a toward the outer diameter side and also has a cylindrical shape. The inner circumferential surface 8a1 of the bearing member 8 (sleeve member 8a) is formed as a cylindrical surface in the shape of a perfect circle with no projections or recesses. The outer circumferential surface of the protrusion 8b constitutes a first outer circumferential surface 8b2 which is a face of the fluid dynamic bearing device 1 exposed to the air. The outer circumferential surface of the sleeve member 8a is divided into a lower second outer circumferential surface 8a2 and an upper third outer circumferential surface 8a3 by the axial direction region in which the protrusion 8b is formed. The second outer circumferential surface 8a2 and the third outer circumferential surface 8a3 are formed to have smaller diameters than the first outer circumferential surface 8b2. Moreover, in this embodiment, the second outer circumferential surface 8a2 serves as a mating portion P with the cover member 8, and the third outer circumferential surface 8a3 serves as a mating portion Q with the sealing member 9.

Moreover, although not illustrated, in part of the annular region of a lower end face 8a4 which serves as a thrust bearing face B of a thrust bearing portion T1, a plurality of dynamic pressure grooves arranged, for example, in a spiral shape are formed, for example, by mold-forming simultaneously in molding of the bearing member 8.

On the first outer circumferential surface 8b2 of the bearing member 8, a pore sealing portion 17 obtained by curing aggregates of a minute amount of the ink (resin composition) is formed, and the pores on the surface of the first outer circumferential surface 8b2 of the bearing member 8 are sealed by forming the pore sealing portion 17. The pore sealing portion 17 is formed by a procedure comprising a first step for forming a coating 18 of a coupling agent on the first outer circumferential surface 8b2 of a material 8′ constituting the bearing member 8, a second step for providing the ink onto the surface of the coating 18 formed in the first step, and a third step for curing the provided ink.

In the first step, as shown in the expanded sectional view to the lower right of FIG. 2, the coating 18 of the coupling agent is formed on the outer circumferential surface of the material 8′ constituting the bearing member 8 (coupling process). It suffices that the coating 18 is formed only on the outer circumferential surface of the material 8′ which is provided with the ink in at least the following second step, specifically the face excluding the mating portions P, Q with other components of the outer circumferential surface, that is, the first outer circumferential surface 8b2. The coating 18 may be formed not only on the first outer circumferential surface 8b2, but also on other outer circumferential surfaces 8a2, 8a3, and even on the end faces thereof.

The coating 18 of the coupling agent is formed by diluting the coupling agent, for example, with isopropyl alcohol, acetone or like solvent to 0.5 wt. %, applying this by a known method such as the spraying method and drying the same. In the portion where the coating 18 is formed, wettability is lowered, in other words, surface tension is increased. Therefore, penetration of the ink into the bearing member when the ink is provided in the second step can be prevented.

As the coupling agent for forming the coating 18, titanate-based, silane-based, aluminium-based and zirconate-based coupling agents can be used. Considering industrial stability and the compatibility with the ink and the like, titanate-based coupling agents are preferably used. Examples of usable titanate-based coupling agents include monoalkoxy type such as KR41B and KR9SA (both manufactured by Ajinomoto-Fine-Techno Co., Inc.), chelate type such as KR138S and KR238S (both manufactured by Ajinomoto-Fine-Techno Co., Inc.), monoalkoxy pyrophosphate type, coordination type and coordinate type.

After the coating 18 is formed in the first step described above, the pore sealing portion 17 is formed by the procedure comprising the second step for providing the ink on the surface of the coating 18 and the third step for curing the ink. As an example of the method of providing the ink in the second step, this embodiment employs the ink jet method in which a fluid ink is discharged from a nozzle in a state of microdroplets, and the surface of the coating 18 on which the ink is to be fixed is hit so that the pore sealing portion 17 is printed and cured.

FIG. 3 shows the outline of an ink jet printing apparatus which carries out printing and curing of the pore sealing portion 17. This printing apparatus comprises one or more nozzle heads 20 which oppose the outer circumferential surface (especially the first outer circumferential surface 8b2) of the material 8′ constituting the bearing member 8 which is rotationally driven, and a curing member 21 disposed in a position different from the nozzle head 20 in the circumferential direction. A plurality of nozzles 24 which discharge microdroplets of the ink 22 are provided on the nozzle head 20 in the axial direction. The curing member 21 is a light source which radiates a light for curing the ink 22, which is, for example, an ultraviolet lamp.

The ink 22 comprises, for example, a light curable resin, preferably ultraviolet curable resin as a base resin, and is prepared by adding, if necessary, a photopolymerization initiator, and if still necessary, an organic solvent. Examples of the base resin include radical polymerizable monomers, radical polymerizable oligomers, cationic polymerizable monomers, imide acrylate, and en-thiol compounds typically including cyclic polyene compounds and polythiol compounds. Among these, radical polymerizable monomers, radical polymerizable oligomers and cationic polymerizable monomers can be preferably used. Moreover, as photopolymerization initiators added to these base resins, radical-based photopolymerization initiators, cationic photopolymerization initiator and the like can be preferably used. Polymerization initiators may be used not only singly but also in combination of two or more kinds.

The material 8′ is rotationally driven by inserting, for example, a fixture 25 made of stainless steel into a through hole in the axial direction and supporting the fixture 25 at its both ends by supporting members 23. At this time, the outer circumferential surface of the fixture 25 and the inner circumferential surface 8a1 of the material 8′ are set to fit to such a degree that the material 8′ can rotate in synchronization with the fixture 25. Otherwise, these surfaces may be fitted more loosely to rotationally drive the bearing member 8 directly. One or more pieces of the material 8′ are supported in a state of being connected serially. From the perspective of efficiently carrying out printing, it is desirable that more than one pieces of the materials 8′ are supported in a state of being serially connected as in the illustrated example. Even when more than one pieces of the material 8′ are serially connected, coaxiality between each piece of the material 8′ is maintained by connecting the materials 8′ using the fixture 25, whereby variation in the accuracy of providing the ink 22 can be prevented, and the highly precise pore sealing portion 17 can be formed on each material 8′.

In the constitution described above, printing is carried out by discharging the ink 22 from the nozzles 24 of the nozzle head 20 while the fixture 25 (material 8′) is rotated. Accordingly, microdroplets of the ink 22 land in the surface of the coating 18, and the pore sealing portion 17 having a predetermined thickness is formed by aggregates of these microdroplets. The “predetermined thickness” is not limited to a particular thickness as long as leakage of the lubricating oil can be prevented. For example, it may be any thickness which ranges from a few micrometers to a few tens of micrometers and can be formed by the present printing method. The rotation of the material 8′ causes the printed pore sealing portion 17 to reach a region opposing the curing member 21 (third step in which the ink is cured) and to be sequentially cured by the polymerization reaction of the ink 22 which has been irradiated with an ultraviolet ray. These printing and curing may be completed while the material 8′ is rotated once, or may be gradually proceeded while it is rotated twice to a few tens of times. At this time, the nozzle head 20 may be disposed in a fixed position during printing of the pore sealing portion 17 or may be slid in the axial direction during printing.

In the printing method by the ink jet method described above, since the second step in which the ink 22 is provided (printing) and the third step in which the provided ink 22 is cured are carried out in succession with no time lag, the pore sealing portion 17 can be formed efficiently. Moreover, in the printing method by the ink jet method, a printing range and printing form can be highly accurately controlled by programming in advance. Therefore, application of masking on a portion which does not require printing is unnecessary. Furthermore, excessive use of the ink can be inhibited and forming the pore sealing portion 17 at low costs is made possible.

The shaft member 2 consists of the shaft portion 2a which is formed of a metallic material such as stainless steel, and a flange portion 2b which is also formed of a metallic material such as stainless steel and provided on one end of the shaft portion 2a integrally or separately. On the outer circumferential surface 2a1 of the shaft portion 2a, as the dynamic pressure generating portion, for example, a region (radial bearing face A) comprising dynamic pressure grooves Ab arranged in a herringbone shape and demarcation portions Aa which demarcate and form the dynamic pressure grooves Ab are formed in two areas spaced in the axial direction. On the upper radial bearing face A, the dynamic pressure grooves Ab are formed axially asymmetrically relative to the axial center m, and the axial dimension X1 of the region above the axial center m is greater than the axial dimension X2 of the region below the axial center m. Accordingly, when the shaft member 2 is in rotation, the drawing force (pumping force) of the lubricating oil by the dynamic pressure grooves Ab is relatively greater in the upper radial bearing face than in the lower symmetrical radial bearing face A. In this embodiment, both the shaft portion 2a and the flange portion 2b are formed of metallic materials, but, for example, it is also possible to form the shaft portion 2a of a metallic material and the flange portion 2b of a resin material.

In this embodiment, the region which serves as the radial bearing face A (dynamic pressure groove pattern) is formed by, as in the formation of the pore sealing portion 17 described above, discharging a fluid ink onto the surface of the material 2a′ constituting the shaft portion 2a from the nozzles in microdroplets and causing the ink to land in the surface of the material 2a′ to be fixed so that the dynamic pressure groove pattern is printed and cured. Printing of the dynamic pressure groove pattern can be carried out by utilizing the same ink jet printing apparatus for forming the pore sealing portion 17 stated above. FIG. 4 shows an example of the apparatus.

Printing of the dynamic pressure groove pattern is carried out by discharging the ink 22 from the nozzles 24 on the nozzle head 20 while the material 2a′ constituting the shaft portion 2a is supported at its both ends by the supporting member 23 and rotated, as shown in FIG. 4. Accordingly, microdroplets of the ink 22 hit a predetermined position of the outer circumferential surface 2a1 of the material 2a′. By collecting a large number of these microdroplets, the dynamic pressure groove pattern (the region which serves as the radial bearing face A) having a plurality of the dynamic pressure grooves Ab, for example, arranged in a herringbone shape and the raised demarcation portions Aa which demarcate and form the dynamic pressure grooves Ab is formed on the outer circumferential surface 2a1 of the material 2a′ as the dynamic pressure generating portion.

Moreover, as shown in FIG. 5, printing of the dynamic pressure groove pattern can be also carried out simultaneously on more than one pieces of the material 2a′ by serially coupling them, and sliding one or more nozzle heads 20 in the axial direction while these materials are rotated simultaneously. In this case, the coaxiality between the pieces of the material 2a′ is ensured, for example, by fitting a projection 2a2 provided at one end of the shaft into a recess provided at the other end.

The dynamic pressure groove pattern formed by undergoing the printing by the ink jet method and curing in such a manner can be used as the radial bearing face A as it is without undergoing a later step such as a cleaning step after machining.

The lower opening of the bearing member 8 is sealed by the cover member 7 formed of a metallic material or a resin material. The cover member 7 is formed in the shape of a bottomed cylindrical shape comprising a bottom 7b and a cylindrical side portion 7a which projects upwardly in the axial direction from the upper end of the bottom 7b on the outer diameter side. The inner circumferential surface 7a2 of the side portion 7a is fittedly fixed on the second outer circumferential surface 8a2 of the bearing member 8 serving as the mating portion P by means of press fitting, press fitting adhesion or the like, and the upper end face 7a1 of the side portion 7a is in contact with the lower end face 8b3 of the protrusion 8b of the bearing member 8. Moreover, in part of the annular region of the upper end face 7b1 of the bottom 7b, for example, the second thrust bearing face C having a plurality of dynamic pressure grooves arranged in a spiral shape is formed, for example, by a press process (not illustrated).

When the cover member 7 having the constitution described above is fixed on the bearing member 8, the width of the thrust bearing gap can be readily set to be constant. That is, if the total value of the axial dimension L1 of the second outer circumferential surface 8b2 of the bearing member 8 and the sum L2 of the axial dimensions of the thrust bearing gap and the flange portion 2b are set to be the same (L=L1+L2) as the axial dimension L of the side portion 7a of the cover member 7, the width of the thrust bearing gap can be readily set to be a uniform value in fixing the cover member 7.

The sealing member 9 for sealing the opening is fixed on the opening of the bearing member 8 at the upper end. The sealing member 9 comprises a disk portion 9a which is in the shape of a disk and has a portion protruding toward the inside diameter side than the inner circumferential surface 8a1 of the bearing member 8, and a cylindrical side portion 9b projecting downwardly in the axial direction from the outer diameter side of the disk portion 9a. As a metallic material for forming the sealing member 9, stainless steel, brass, aluminium and other materials are usable. However, when the identical material is used, there is a risk of burning caused by the sliding contact with the shaft member 2 may occur. Therefore, it is desirable to form the sealing member 9 of a metallic material different from the shaft member 2.

The inner circumferential surface of the disk portion 9a of the sealing member 9 comprises a first inner circumferential surface 9a1 which forms a cylindrical face in the shape of a perfect circle with no projections and recesses and a tapering second inner circumferential surface 9a2 whose diameter gradually increases upwardly in the axial direction from the upper end of the first inner circumferential surface 9a1. The second inner circumferential surface 9a2 opposes the outer circumferential surface 2a1 of the shaft portion 2a across a sealing space S having a predetermined capacity. The inner circumferential surface 9b1 of the side portion 9b is fixed on the third outer circumferential surface 8a3 of the bearing member 8 serving as the mating portion Q by means of press fitting, press fitting adhesion or the like, and the lower end face 9b2 of the side portion 9b is in contact with an upper end face 8b1 of the protrusion 8b of the bearing member 8. Moreover, part of the region in the radial direction of a lower end face 9a3 of the disk portion 9a is in contact with an upper end face 8a5 of the sleeve member 8a of the bearing member 8. After the fluid dynamic bearing device 1 is assembled, the inner space of the fluid dynamic bearing device 1 sealed by the sealing member 9 is filled with, for example, the lubricating oil as a lubricating fluid. In this state, the oil level of the lubricating oil is maintained within the range of the sealing space S.

When the sealing member 9 is fixed on the bearing member 8 in a manner mentioned above, a stepped portion 16 in the radial direction is formed between the first inner circumferential surface 9a1 of the disk portion 9a of the sealing member 9 and the inner circumferential surface 8a1 of the bearing member 8. To facilitate understanding, the stepped portion 16 is exaggeratedly drawn in the Fig., but the dimension of the stepped portion 16 is about 2 μm to 20 μm. Moreover, the outer circumferential surface of the cover member 7, the outer circumferential surface of the sealing member 9 and the outer circumferential surface of the pore sealing portion 17 formed on the bearing member 8 are formed in such a manner of being on the same straight line.

In the fluid dynamic bearing device 1 having the constitution described above, when the shaft member 2 is rotated, the two radial bearing faces A formed on the outer circumferential surface 2a1 of the shaft portion 2a oppose the inner circumferential surface 8a1 of the bearing member 8, respectively, across the radial bearing gap. Rotation of the shaft member 2 generates the dynamic pressure effect in the lubricating oil filling each radial bearing gap, and the shaft member 2 is freely rotatably supported in the radial direction in a non-contact manner by the pressure. Accordingly, radial bearing portions R1, R2 which rotatably support the shaft member 2 in the radial direction in a non-contact manner are formed. These radial bearing portions R1, R2 constitute a first bearing portion 14 comprising two dynamic pressure bearings provided apart from each other in the axial direction.

Simultaneously, a film of the lubricating oil is formed in the radial bearing gap between the first inner circumferential surface 9a1 of the sealing member 9 and the opposing outer circumferential surface 2a1 of the shaft portion 2a, and the shaft member 2 is rotatably supported in the radial direction in a non-contact manner by this lubricating oil film. Accordingly, a second bearing portion 15 consisting of a cylindrical bearing is constituted. Since the outer circumferential surface 2a1 of the shaft portion 2a has a constant diameter regardless of the region opposing the inner circumferential surface 8a1 of the bearing member 8 and the first inner circumferential surface 9a1 of the sealing member 9, the width of the radial bearing gap W2 in the second bearing portion 15 becomes smaller than the width of the radial bearing gap W1 of the first bearing portion 14 (distance between the outer circumferential surface of the raised demarcation portion Aa and the large-diameter inner circumferential surface 8a1) (W2<W1) because of the existence of the stepped portion 16 mentioned above.

Moreover, the thrust bearing face B formed on the lower end face 8a4 of the sleeve member 8a of the bearing member 8 opposes an upper end face 2b1 of the flange portion 2b across the thrust bearing gap, and the thrust bearing face C formed on the upper end face 7b1 of the bottom 7b of the cover member 7 opposes a lower end face 2b2 of the flange portion 2b across the thrust bearing gap. Rotation of the shaft member 2 generates the dynamic pressure effect in the lubricating oil filling each thrust bearing gap, and the shaft member 2 is freely rotatably supported in the thrust direction in a non-contact manner by the pressure. Accordingly, thrust bearing portions T1, T2 which freely rotatably support the shaft member 2 in both thrust directions in a non-contact manner are formed.

In the present invention, the pore sealing portion 17 is formed by curing aggregates of a minute amount of the ink on the first outer circumferential surface 8b2 of the bearing member 8 made of a sintered metal, that is, the outer circumferential surface excluding the outer circumferential surfaces 8a2, 8a3 which serve as the mating portion P with the cover member 7 and the sealing member 9, whereby the pores on the surface of the bearing member 8 are sealed. This prevents the lubricating oil from flowing out of the bearing device. Therefore, not only the deterioration of the adhesiveness when it is integrated into the motor is prevented but also contamination of motor components can be prevented. Moreover, prevention of burning of the shaft member 2 and the bearing member 8 caused by a decrease in the amount of oil in the bearing device can be also achieved, and a contemplated rotational accuracy can be maintained. Furthermore, a component (for example, housing) for containing the bearing member 8, which has been conventionally, used can be omitted, and such reduction in the number of parts and assembling man-hour lead to reduced costs of the fluid dynamic bearing device 1.

Moreover in the present invention, the width of the radial bearing gap W2 in the second bearing portion 15 consisting of the cylindrical bearing is smaller than the width of the radial bearing gap W1 in the first bearing portion 14 consisting of the dynamic pressure bearing as mentioned above. Accordingly, when the bearing device is started or stopped, or when runout of the shaft member 2 is present during the operation of the bearing device, sliding contact with the shaft member 2 occurs preferentially in the second bearing portion 15 having a small bearing gap width, and sliding contact between the components in the first bearing portion 14 is thus avoided. Therefore, abrasion of the demarcation portions Aa made of a resin formed on the radial bearing faces A of the first bearing portion 14 can be inhibited, whereby a decrease in the dynamic pressure effect on the radial bearing faces A can be prevented and contemplated bearing performance can be maintained for a long period of time. Moreover, sliding of the sealing member 9 and the shaft member 2 in the second bearing portion 15 is made metal contact, whereby early abrasion of the contact surface can be inhibited.

Moreover, formation of the pore sealing portion 17 and the radial bearing face A (dynamic pressure groove pattern) can be processed by the same apparatus if programs and others are partly changed. Therefore, investment in equipment can be kept to a low level and the production costs of the fluid dynamic bearing device 1 can be reduced.

From the functions mentioned above, the fluid dynamic bearing device 1 which can prevent leakage of the oil, has good assemblability with the motor and excellent cleanliness can be provided at low costs according to the present invention. In addition, this fluid dynamic bearing device 1 has high rotational accuracy and durability.

In the above description, the case where among the radial bearing faces A provided in two positions in the axial direction of the shaft portion 2a, the dynamic pressure grooves Ab on the upper radial bearing face A in the axial direction are formed axially asymmetrically relative to the axial center m is shown. However, when the fluid dynamic bearing device 1 having the constitution of the present invention is used, for example, in a fan motor or a polygon scanner motor for laser beam printers integrated therein, the grooves may be arranged symmetrically in the axial direction as the dynamic pressure grooves provided on the lower radial bearing faces A in the axial direction.

In the above description, the case where the radial bearing faces A is formed on the outer circumferential surface 2a1 of the shaft portion 2a is shown as an example, but the radial bearing faces A can be also formed on the inner circumferential surface 8a1 of the bearing member 8. Moreover, the case where the thrust bearing face B is formed on the lower end face 8a4 of the bearing member 8 and the thrust bearing face C is formed on the upper end face 7b1 of the cover member 7 is shown as an example. However, these thrust bearing faces B and C may be formed on the upper end face 2b1 and lower end face 2b2, respectively, of the flange portion 2b which oppose each other across the thrust bearing gap. Moreover, the case where only the radial bearing faces A is formed by printing using the ink jet method as an example, but the thrust bearing faces B and C may be also formed by printing using the ink jet method.

Moreover, the description of the fluid dynamic bearing device in which the thrust bearing portion is constituted by a dynamic pressure bearing is provided above, but the thrust bearing portion may be also constituted of a so-called pivot bearing (not illustrated).

By the way, the configuration of the dynamic pressure generating portion formed on the radial bearing faces A shown above is just an example, and a dynamic pressure groove pattern corresponding to any other configuration of the dynamic pressure grooves (for example, spiral shape) can be formed as the dynamic pressure generating portion as long as it can be printed by the ink jet method. On the radial bearing face A, a so-called multi-arc dynamic pressure generating portion in which a plurality of arcuate faces in the circumferential direction are formed, and further a so-called stepped dynamic pressure generating portion in which dynamic pressure grooves in the axial direction are formed in more than one positions in the circumferential direction can be also formed by a similar method.

Moreover, in the above description, the case where the radial bearing faces A are formed separately in two positions in the axial direction is shown as an example, but the number of the radial bearing faces A is optional, and the radial bearing face A can be formed in a position or thee or more positions in the axial direction.

The structure of the first bearing portion 14 in which a multi-arc dynamic pressure generating portion is formed on the radial bearing face A is shown in FIGS. 6 to 8 as examples. In the embodiment shown in FIG. 6, a plurality of arcuate faces 2a3 and separation grooves 2a4 in the axial direction are formed by a printing step by the ink jet method mentioned above on the outer circumferential surface 2a1 of the shaft portion 2a and a curing step of the printed surface. Each of the arcuate faces 2a3 is an eccentric arcuate face whose center is a point offset from the rotation axis O in the same distance, and is formed at regular intervals in the circumferential direction. By inserting this shaft portion 2a at the inner circumferential surface 8a1 of the bearing member 8, the radial bearing gaps in the radial bearing portions R1, R2 are formed between the eccentric arcuate faces 2a3 and separation groove 2a4 of the shaft portion 2a, respectively. Of the radial bearing gaps, the region opposing the eccentric arcuate faces 2a3 is in the shape of a wedge whose width decreases gradually in one of the circumferential directions. This bearing is also referred to as a taper bearing. When the shaft member 2 is rotated in the direction of decreasing of the wedge-shaped gap, the pressure of the lubricating oil pushed toward the contracting side of the wedge-shaped gap increases. Therefore, the radial bearing portions R1, R2 consisting of hydrodynamic bearings are constituted by this dynamic pressure effect.

In this case, the same effect as in the embodiment shown in FIG. 2 can be obtained by making the width of the radial bearing gap W2 of the second bearing portion 15 (refer to FIG. 2) smaller than the minimum width of the wedge-shaped gap.

In FIG. 7, in the constitution shown in FIG. 6, a predetermined regions θ on the minimum gap side of the eccentric arcuate faces 2a3 are constituted of concentric arcs whose centers are the rotation axis O. Such a bearing is sometimes referred to as a taper flat bearing. In this case, since the width of the radial bearing gap is constant in each predetermined region θ, the width W2 of the bearing gap in the second bearing portion 15 can be made smaller than this width so that the same effect as in the embodiment shown in FIG. 2 can be obtained.

In FIG. 8, the radial bearing face on the outer circumferential surface of the shaft portion 2a is formed by a plurality of arcuate faces 2a3. The centers of the arcuate faces 2a3 are offset from the rotation axis O in the same distance. In this case, the radial bearing gap has such a configuration that it gradually contracts in both circumferential directions. Also in this case, the width of the radial bearing gap W2 in the second bearing portion 15 can be made smaller than the minimum width of the wedge-shaped gap so that the same effect as in the embodiment shown in FIG. 2 can be obtained.

Moreover, the dynamic pressure generating portion formed on the thrust bearing faces B, C may be dynamic pressure generating portions having the dynamic pressure grooves arranged in a spiral shape or other shapes mentioned above, or, for example, stepped dynamic pressure generating portions, which is a so-called a wave shape (the steps are wave shaped).

Moreover, although the above description discusses the form in which a lubricating oil is used as the lubricating fluid filling the inside of the fluid dynamic bearing device 1 as an example, other fluids which can produce the hydrodynamic pressure in each bearing gap, for example, magnetic fluids and gases such as air can be also used.

### BRIEF DESCRIPTION OF THE DRAWINGS

FIG. 1 is a schematic drawing showing an example of a motor integrating a fluid dynamic bearing device.

FIG. 2 is a sectional view showing an example of the fluid dynamic bearing device.

FIG. 3 is a schematic drawing showing an example of the printing apparatus by the ink jet method for forming the pore sealing portion.

FIG. 4 is a schematic drawing showing an example of the printing apparatus by the ink jet method for forming the dynamic pressure generating portion.

FIG. 5 is a schematic drawing showing another form of the printing apparatus by the ink jet method for forming the dynamic pressure generating portion.

FIG. 6 is a sectional view showing another form of the dynamic pressure generating portion.

FIG. 7 is a sectional view showing another form of the dynamic pressure generating portion.

FIG. 8 is a sectional view showing another form of the dynamic pressure generating portion.

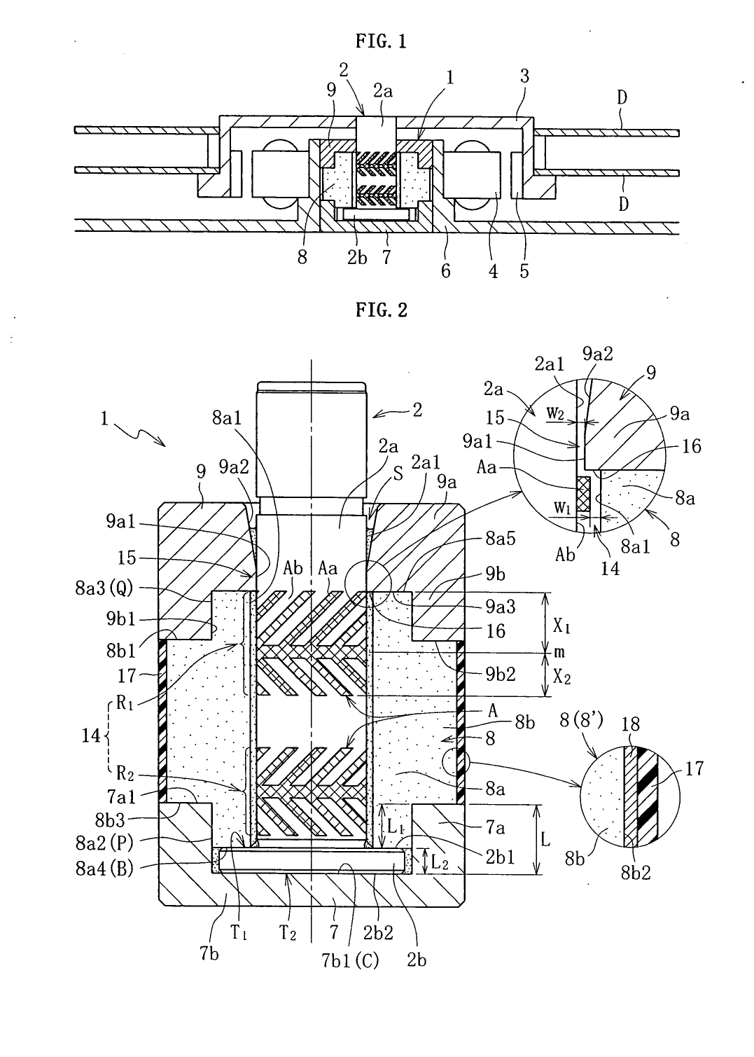

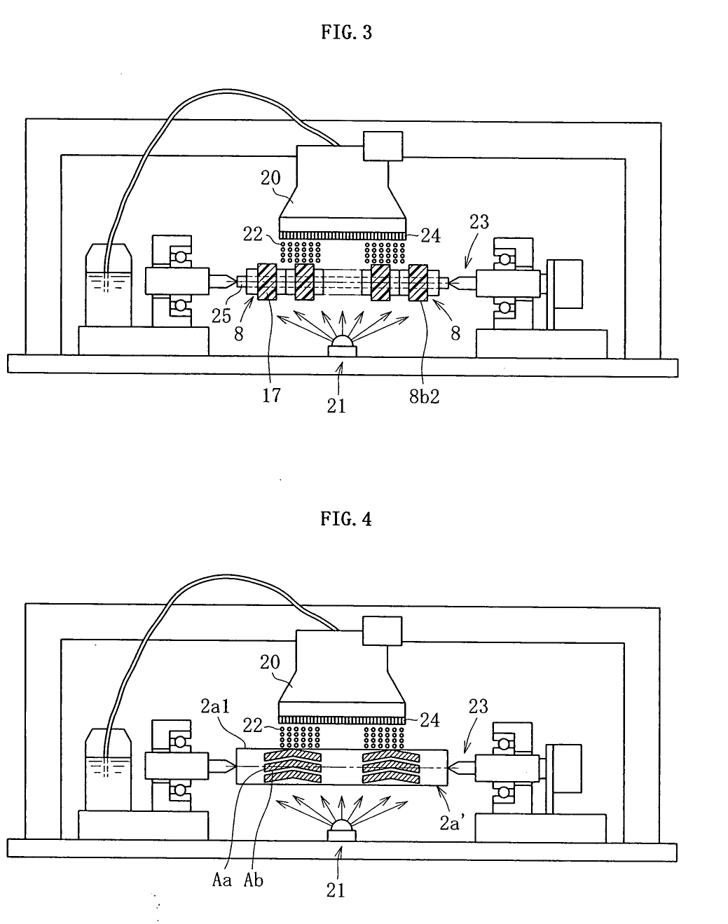

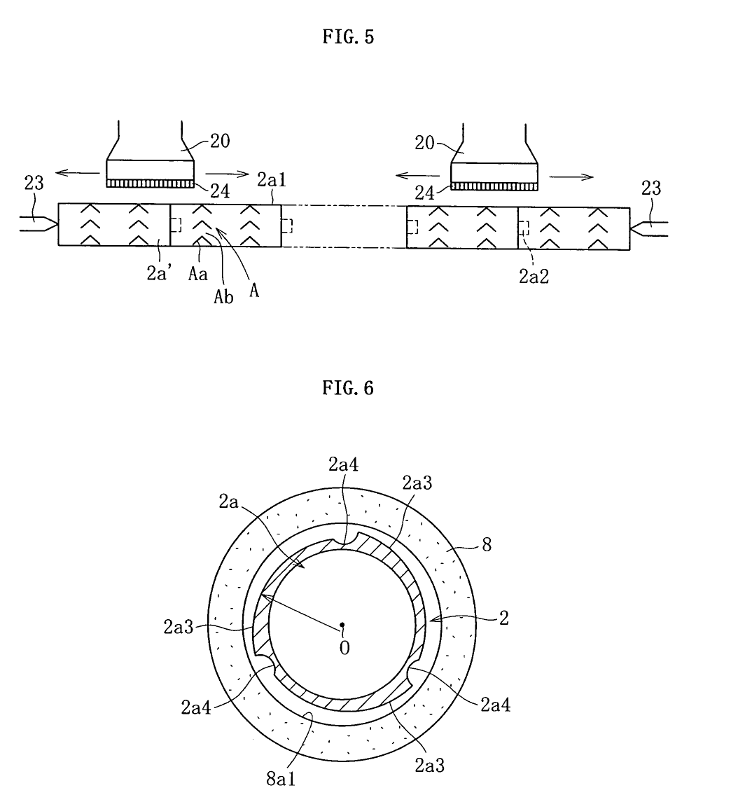

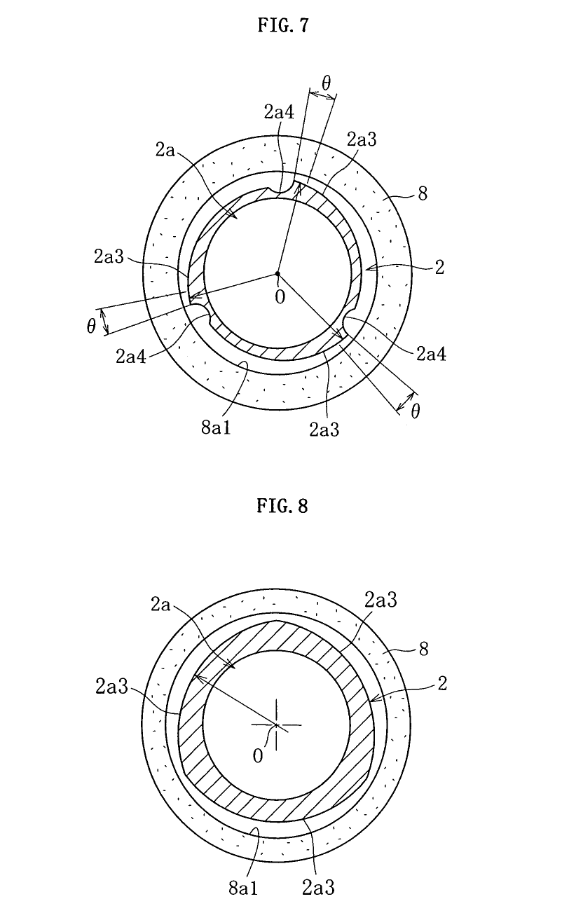

### DESCRIPTION OF THE NUMERALS

1 Fluid dynamic bearing device
2 Shaft member
2a′ Material
8 Bearing member
8′ Material
8b2 First outer circumferential surface
8a2 Second outer circumferential surface
14 First bearing portion
15 Second bearing portion
16 Stepped portion
17 Pore sealing portion
18 Coating
20 Nozzle head
21 Curing member

### 22 Ink

A Radial bearing face
B, C Thrust bearing faces
Aa Demarcation portion
Ab Dynamic pressure grooves
P Mating portion
Q Mating portion
R1, R2 Radial bearing portions
T1, T2 Thrust bearing portions
S Sealing space

1. A fluid dynamic bearing device comprising a shaft member, a bearing member which is made of a sintered metal and comprises the shaft member inserted at its inner periphery, and a radial bearing gap formed between the outer circumferential surface of the shaft member and the opposing inner circumferential surface of the bearing member and filled with a lubricating fluid,
wherein a pore sealing portion for sealing surface pores by curing aggregates of a minute amount of an ink provided on the outer circumferential surface of the bearing member is provided.

2. A fluid dynamic bearing device according to claim 1, wherein a coating of the coupling agent is provided on the outer circumferential surface of the bearing member and then a pore sealing portion is formed.

3. A fluid dynamic bearing device according to claim 1, wherein the pore sealing portion is formed excluding a mating portion with another component which fits the outer circumferential surface of the bearing member.

4. A fluid dynamic bearing device according to claim 3, wherein said another component is a cover member which seals an opening at one end of the bearing member.

5. A fluid dynamic bearing device according to claim 3, wherein said another component is a sealing member which seals the opening at the other end of the bearing member.

6. A fluid dynamic bearing device according to claim 1 which comprises a first bearing portion having a fluid dynamic pressure generating portion for generating a dynamic pressure action in the radial bearing gap, and a second bearing portion having a radial bearing gap whose width is smaller than a radial bearing gap of the first bearing portion, the second bearing portion constituting a cylindrical bearing.

7. A fluid dynamic bearing device according to claim 6, wherein the radial bearing gap of the second bearing portion is formed between the inner circumferential surface of the sealing member which seals the opening at the other end of the bearing member and the outer circumferential surface of the shaft member.

8. A fluid dynamic bearing device according to claim 6, wherein the dynamic pressure generating portion of the first bearing portion is formed by curing aggregates of a minute amount of the ink.

9. A fluid dynamic bearing device according to claim 1, wherein the ink has light curability.

10. A motor having a fluid dynamic bearing device according to claim 1, a stator coil and a rotor magnet.

11. A fluid dynamic bearing device according to claim 8, wherein the ink has light curability.
